(19) United States
(12) Patent Application Publication
(10) Pub. No.: US 2025/0374945 A1
(43) Pub. Date: Dec. 11, 2025

(54) HEALTHY POWDERED OR GRANULATED SWEETENER

(71) Applicant: Sugar License LLC, Newton, MA (US)

(72) Inventor: Ross Anapolle, Newton, MA (US)

(73) Assignee: Sugar License LLC, Newton, MA (US)

(21) Appl. No.: 19/088,753

(22) Filed: Mar. 24, 2025

Related U.S. Application Data
(63) Continuation-in-part of application No. 18/617,463, filed on Mar. 26, 2024.
(60) Provisional application No. 63/454,906, filed on Mar. 27, 2023.
(60) Provisional application No. 63/535,550, filed on Aug. 30, 2023.
(60) Provisional application No. 63/539,559, filed on Sep. 20, 2023.
(60) Provisional application No. 63/598,528, filed on Nov. 13, 2023.
(60) Provisional application No. 63/569,619, filed on Mar. 25, 2024.

(51) Int. Cl. A23L 27/30; A23L 2/60; A23L 27/12

(52) U.S. Cl. CPC A23L 27/33; A23L 2/60; A23L 27/12; A23L 27/32; A23L 27/34; A23L 27/36

(57) ABSTRACT

Food and/or beverage additives are generally provided. In some embodiments, the additive comprises a sweetener (e.g., a healthy sweetener). In some embodiments, the additive and/or sweetener is a solid. The additives and/or sweeteners described herein may be useful when added a food and/or beverage e.g., to increase the sweetness of a food and/or beverage. In some embodiments, the additives and/or sweeteners may advantageously be used to reduce the sugar and/or caloric content of a food and/or beverage (e.g., as compared to the food and/or beverage without the additive and/or sweetener). Advantageously, the additives comprising the sweeteners described herein may be useful for providing a food and/or beverage having a relatively low glycemic index and/or a relatively low number of calories per serving.

### RELATED APPLICATIONS

This application claims priority to and benefit of: U.S. Provisional Application Ser. No. 63/569,619, filed Mar. 25, 2024, entitled “HEALTHY POWDERED OR GRANULATED SWEETENER”; this application is also a continuation-in-part of U.S. application Ser. No. 18/617,463, filed Mar. 26, 2024, entitled “HEALTHY SWEETENER”, which claims priority to and benefit of: U.S. Provisional Application Ser. No. 63/454,906, filed Mar. 27, 2023, entitled “HEALTHY SWEETENER”; U.S. Provisional Application Ser. No. 63/535,550, filed Aug. 30, 2023, entitled “HEALTHY SWEETENER”; U.S. Provisional Application Ser. No. 63/539,559, filed Sep. 20, 2023, entitled “HEALTHY SWEETENER”; and U.S. Provisional Application No. 63/598,528, filed Nov. 13, 2023, entitled “HEALTHY SWEETENER,” each of the aforementioned applications is hereby expressly incorporated by reference in its entirety for all purposes.

### FIELD

The present inventive concepts generally relate to the field of additives comprising sweeteners, in particular, the present invention generally relates to healthy sweeteners for use in food and beverages.

### SUMMARY

The subject matter of the present disclosure involves, in some cases, interrelated products, alternative solutions to a particular problem, and/or a plurality of different uses of one or more systems and/or articles.

Aspects of the present disclosure generally relate to additives comprising healthy sweeteners (e.g., for use in food and/or beverages).

In one aspect, a food and/or beverage additive is provided, the additive comprising a sweetener comprising fructose present in an amount greater than or equal to 20 wt % and less than or equal to 60 wt % versus the total weight of the sweetener, glucose present in an amount greater than or equal to 5 wt % and less than or equal to 35 wt % versus the total weight of the sweetener, sorbitol present in an amount greater than or equal to 0.5 wt % and less than or equal to 10 wt % versus the total weight of the sweetener, and sucrose present in an amount greater than or equal to 0 wt % and less than or equal to 20 wt %, wherein the sweetener is solid and has one or more of the following properties i) a glycemic index of less than or equal to 55 as measured according to ISO 26642:2010 and/or ii) a number of calories of less than or equal to 20 kilocalories per 4 grams of sweetener as measured using a bomb calorimeter.

In another aspect, edible consumer products are provided. In some embodiments, the edible consumer product comprises a food product and a coating and/or powder, the coating and/or powder comprising a sweetener, wherein the sweetener is a solid and the sweetener comprising fructose present in an amount greater than or equal to 20 wt % and less than or equal to 60 wt % versus the total weight of the sweetener, glucose present in an amount greater than or equal to 5 wt % and less than or equal to 35 wt % versus the total weight of the sweetener, sorbitol present in an amount greater than or equal to 0.5 wt % and less than or equal to 10 wt % versus the total weight of the sweetener, and sucrose present in an amount greater than or equal to 0 wt % and less than or equal to 20 wt %.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1A and 1B are schematic diagrams of edible consumer products and additives, according to one set of embodiments.

### DETAILED DESCRIPTION

Aspects of the present disclosure generally relate to additives comprising healthy sweeteners (e.g., for use in food and/or beverages). The present inventive concept may, however, be embodied in many different forms and should not be construed as limited to the exemplary embodiments set forth herein.

Food and/or beverage additives are generally provided. In some embodiments, the additive comprises a sweetener (e.g., a healthy sweetener). In some embodiments, the additive and/or sweeteners are solid (e.g., a crystalline grain, a granular solid, a solid powder, a dehydrated solid). The additives and/or sweeteners described herein may be useful when added a food and/or beverage e.g., to increase the sweetness of a food and/or beverage. In some embodiments, the additives and/or sweeteners may advantageously be used to reduce the sugar and/or caloric content of a food and/or beverage (e.g., as compared to the food and/or beverage without the additive and/or sweetener). Advantageously, the additives comprising the sweeteners described herein may be useful for providing a food and/or beverage having a relatively low glycemic index and/or a relatively low number of calories per serving.

Advantageously, foods and/or beverages (e.g., juice concentrates) comprising the additives and/or sweeteners described herein may have lower amounts of fructose as compared to the amount of fructose typically present in such beverages/foods, e.g., that are sweetened with conventional sweeteners. Without wishing to be bound by theory, by lowering the amount of fructose in a beverage (or food) (e.g., effective increasing the ratio of other sugars present in the beverage/food, such as glucose), a relatively low glycemic index may be obtained. As recognized by the inventors, lower levels of fructose may provide benefits to a consumer. The term “consumer,” as used herein, refers to an individual organism such as a human or an animal. In some embodiments, the consumer is a mammal (e.g., a human, a non-human primate, or a non-human mammal), a vertebrate, a laboratory animal, a domesticated animal, an agricultural animal, or a companion animal. In some embodiments, the consumer is a human. In some embodiments, the consumer is a rodent, a mouse, a rat, a hamster, a rabbit, a dog, a cat, a cow, a goat, a sheep, or a pig.

As generally described herein, the additive comprises a solid. In some embodiments, the additive is a solid, such as a sugar crystal and/or powdered sugar. According to some embodiments, the additive generally comprises a sweetener. In some embodiments, the sweetener comprises a combination of two or more of fructose, glucose, sorbitol and, optionally, sucrose, or derivatives thereof. According to some embodiments, the sweetener comprises a solid. In some embodiments, the sweetener is a solid, such as a sugar crystal and/or powdered sugar. For example, in an illustrative embodiment, a powdered sugar product is provided comprises the healthy sweetener and, optionally, an anti-caking, as described in more detail below. The powdered sugar product may be used, in some embodiments, as an additive described herein (e.g., for use with a food and/or beverage product). In another illustrative embodiment, a sugar crystal is provided comprising the healthy sweetener. Other components (e.g., flavorings, dyes, etc.) may also be presented in the sugar crystal(s) and/or powdered sugar, as described in more detail, below.

In some embodiments, fructose is present in the sweetener in an amount greater than or equal to 20 wt %, greater than or equal to 30 wt %, greater than or equal to 40 wt %, greater than or equal to 50 wt %, or greater than or equal to 55 wt % versus the total weight of the sweetener. In some embodiments, fructose is present in the sweetener in an amount less than or equal to 60 wt %, less than or equal to 55 wt %, less than or equal to 50 wt %, less than or equal to 40 wt %, less than or equal to 30 wt %, or less than or equal to 25 wt % versus the total weight of the sweetener. Combinations of the above-referenced ranges are also possible (e.g., greater than or equal to 20 wt % and less than or equal to 60 wt %). Other ranges are also possible. In an exemplary set of embodiments, fructose is present in the sweetener in an amount greater than or equal to 26.9 wt % and less than or equal to 53.6 wt %.

In some embodiments, glucose is present in the sweetener in an amount greater than or equal to 5 wt %, greater than or equal to 10 wt %, greater than or equal to 15 wt %, greater than or equal to 20 wt %, greater than or equal to 25 wt %, or greater than or equal to 30 wt % versus the total weight of the sweetener. In some embodiments, glucose is present in the sweetener in an amount less than or equal to 35 wt %, less than or equal to 30 wt %, less than or equal to 25 wt %, less than or equal to 20 wt %, less than or equal to 15 wt %, or less than or equal to 10 wt % versus the total weight of the sweetener. Combinations of the above-referenced ranges are also possible (e.g., greater than or equal to 5 wt % and less than or equal to 35 wt %). Other ranges are also possible. In an exemplary set of embodiments, glucose is present in the sweetener in an amount greater than or equal to 9 wt % and less than or equal to 30.6 wt %.

In some embodiments, sorbitol is present in the sweetener in an amount greater than or equal to 0.5 wt %, greater than or equal to 1 wt %, greater than or equal to 2 wt %, greater than or equal to 4 wt %, greater than or equal to 6 wt %, or greater than or equal to 8 wt % versus the total weight of the sweetener. In some embodiments, sorbitol is present in the sweetener in an amount less than or equal to 10 wt %, less than or equal to 8 wt %, less than or equal to 6 wt %, less than or equal to 4 wt %, less than or equal to 2 wt %, or less than or equal to 1 wt % versus the total weight of the sweetener. Combinations of the above-referenced ranges are also possible (e.g., greater than or equal to 0.5 wt % and less than or equal to 10 wt %). Other ranges are also possible. In an exemplary set of embodiments, sorbitol is present in the sweetener in an amount greater than or equal to 1.2 wt % and less than or equal to 5.4 wt %.

In some embodiments, sucrose is present in the sweetener in an amount greater than or equal to 0 wt %, greater than or equal to 1 wt %, greater than or equal to 2 wt %, greater than or equal to 5 wt %, greater than or equal to 10 wt %, or greater than or equal to 15 wt % versus the total weight of the sweetener. In some embodiments, sucrose is present in the sweetener in an amount less than or equal to 20 wt %, less than or equal to 15 wt %, less than or equal to 10 wt %, less than or equal to 5 wt %, less than or equal to 2 wt %, or less than or equal to 1 wt % versus the total weight of the sweetener. Combinations of the above-referenced ranges are also possible (e.g., greater than or equal to 0 wt % and less than or equal to 20 wt %). Other ranges are also possible. In an exemplary set of embodiments, sucrose is present in the sweetener in an amount greater than or equal to 0 wt % and less than or equal to 17.9 wt %. In some embodiments, sucrose is absent from the sweetener (e.g., 0 wt %).

In some embodiments, the sweetener has a glycemic index of less than or equal to 55, less than or equal to 50, less than or equal to 45, or less than or equal to 40 (e.g., and greater than or equal to 35, greater than or equal to 40, greater than or equal to 45, or greater than or equal to 50). The glycemic index may be measured, in some embodiments, according to ISO 26642:2010.

In some embodiments, the sweetener has a number of calories of less than or equal to 20 kilocalories, less than or equal to 15 kilocalories, less than or equal to 10 kilocalories, or less than or equal to 5 kilocalories per 4 grams of sweetener. In some embodiments, the sweetener has a number of calories of greater than or equal to 2 kilocalories, greater than or equal to 5 kilocalories, greater than or equal to 10 kilocalories, or greater than or equal to 15 kilocalories per 4 grams of sweetener. Combinations of the above-referenced ranges are also possible (e.g., greater than or equal to 2 kilocalories and less than or equal to 20 kilocalories per 4 grams of sweetener). Other ranges are also possible. The number of calories may be measured, in some embodiments, using a bomb calorimeter according to methods known by those of ordinary skill in the art based upon the teachings of this specification.

In some embodiments, the additive comprises the sweetener and one or more other components. Other components may be any suitable component generally used in foods and/or beverages. In some embodiments, the other components may include anti-caking agents, flavorings, anti-microbial agents, and/or dyes. Other components are also possible. Non-limiting examples of anti-caking agents include corn starch, tapioca starch, potato starch, tricalcium phosphate, silica, maltodextrins, and sodium aluminosilicate. Other anti-caking agents are also possible in the additive. Examples of flavorings that the additive may comprise include, but are not limited to, vanilla, mint, nuts (e.g., almond, hazelnut), fruit components, and coffee. Other flavorings are also possible in the additive. In some embodiments, an anti-microbial agent such as potassium sorbate may be included in the additive. Other anti-microbial agents are also possible in the additive. Various dyes are also suitable for being included within the additive, non-limiting example of which include synthetic and natural food colorings. Other dyes are also possible in the additive.

In some embodiments, the one or more components may independently be present in the additive in an amount of greater than or equal to 0.01 wt %, greater than or equal to 0.1 wt %, greater than or equal to 0.5 wt %, greater than or equal to 1 wt %, greater than or equal to 1.5 wt %, greater than or equal to 2 wt %, greater than or equal to 2.5 wt %, greater than or equal to 3 wt %, greater than or equal to 4 wt %, greater than or equal to 5 wt %, greater than or equal to 6 wt %, greater than or equal to 7 wt %, greater than or equal to 8 wt %, or greater than or equal to 9 wt % versus the total weight of the additive. In some embodiments, the one or more components may independently be present in the additive in an amount of less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2.5 wt %, less than or equal to 2 wt %, less than or equal to 1.5 wt %, less than or equal to 1 wt %, less than or equal to 0.5 wt %, or less than or equal to 0.1 wt % versus the total weight of the additive. Combinations of the foregoing ranges are possible (e.g., greater than or equal to 0.01 wt % and less than or equal to 10 wt %). Other ranges are also possible. According to some embodiments where multiple other components are present in the additive, they collectively may be present in an amount commensurate with any of the foregoing ranges. However, in some embodiments, the additive comprises no additional components other than the sweetener.

In some embodiments, the additive comprises one or more fruit components. For example, in some embodiments, the sweetener is derived from, and/or comprises, one or more fruit components. In some embodiments, the one or more fruit components are derived from a fruit selected from the group consisting of pomes (e.g., apple, pear, quince, loquat, medlar, rowan), citrus (e.g., lemon, grapefruit, orange), gourds, berries and/or aggregate fruits (e.g., blueberry, strawberry, raspberry, cranberry, elderberry, blackberry, currant, banana, tomato, grape, watermelon, pumpkin, melons), and drupes (e.g., mango, peach, plum, cherry, apricot). In an exemplary set of embodiments, the fruit from which the one or more fruit components is derived is an apple.

In some embodiments, the one or more fruit components comprises peel/skin, flesh/pulp, pit, seed, sepal, pistil and/or pedicel. According to some embodiments, the one or more fruit components are derived from apples and comprise peel/skin, flesh/pulp, pit, seed, sepal, pistil and/or pedicel.

In some embodiments, the additive is in powder or granular form. In some embodiments, a sweetener of the additive is in powder or granular form. In some embodiments, the additive is water soluble. According to some embodiments, the additive comprises a sweetener that is water soluble.

Advantageously, the additives and/or sweeteners described herein may have a relatively long shelf life. For example, in some embodiments, the additive and/or sweetener has a shelf-life of greater than or equal to 1 year, greater than or equal to 2 years, greater than or equal to 3 years and/or less than or equal to 5 years, less than or equal to 8 years, or less than or equal to 10 years, at room temperature.

In some embodiments, the sweetener of the additive is substantially colorless and/or substantially odorless.

Advantageously, in some embodiments, the sweetener further comprises one or more additional low glycemic, and/or low caloric, natural and/or artificial sweeteners. Non-limiting examples of suitable additional sweeteners include Stevia, aspartame, sorbitol, erythritol, cane sugar, monk fruit, and other natural and/or artificial sweeteners.

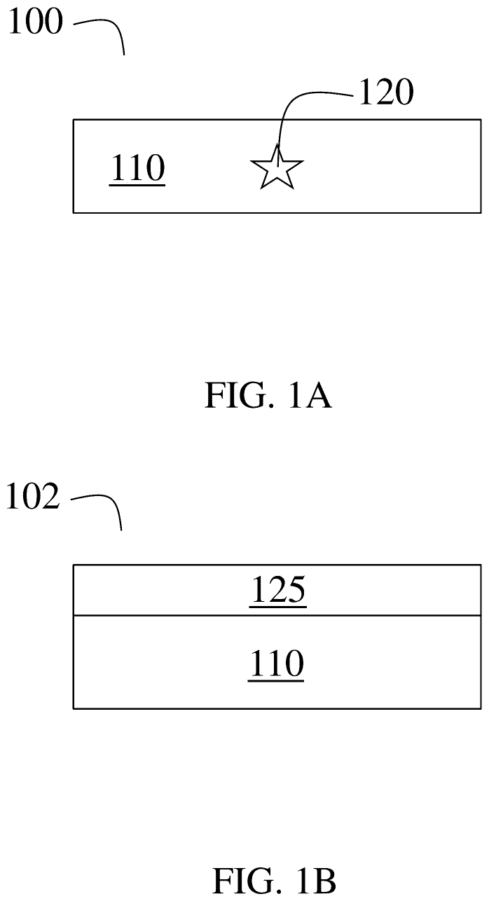

In some embodiments, edible consumer products are provided. In some embodiments, the edible consumer product is a food product. In some embodiments, the edible consumer product is a beverage. FIG. 1A is a schematic diagram showing an exemplary edible consumer product 100 comprising a food and/or beverage 110 and an additive 120. In some embodiments, additive 120 comprises a solid sweetener, as described elsewhere herein. An alternative example of an edible consumer product 102 is shown in FIG. 1B comprising a food and/or beverage 110 and a coating 125. In some embodiments, coating 125 comprises the additive (e.g., a (solid) sweetener). While FIG. 1B depicts coating 125 disposed directly on food and/or beverage 110, those of ordinary skill in the art would understand that one or more intervening layers and/or coatings may be present (e.g., each comprising or not comprising the additive). It would also be understood that FIGS. 1A and 1B are non-limiting examples and are generally included for illustrative purposes. Other arrangements, configurations, and combinations of food, beverages, and additive are also possible.

In some embodiments, edible consumer products are provided. In some embodiments, the edible consumer product is a food and/or beverage product. In some embodiments, consumable consumer products are provided.

In some embodiments, the edible consumer product is a food and comprises a coating and/or powder, the coating and/or powder comprising an additive as described herein.

In some embodiments, the consumable consumer product is a beverage and comprises an additive as described herein (e.g., and may be dissolved and/or remain at least partially solid within the consumable consumer product).

In some embodiments, the edible or consumable consumer product (e.g., food, beverage) meets FDA standards for a “no sugar added” designation according to 21 CFR 101.60(c).

In some embodiments, provided is a healthy sweetener including a composition comprising an apple component, in any one or more of a variety of forms (e.g., as solid, in a powdered or granular form), in combination with at least one sweetener component that lowers the glycemic index and calorie count of the apple component, while preferably increasing its sweetness. In various embodiments, the healthy sweetener is a low-glycemic, low-calorie (LGLC) healthy sweetener.

In some embodiments, the healthy sweetener is formed by blending or otherwise combining the apple component with at least one other low glycemic and/or low caloric sweetener, preferably that increases sweetness.

In an exemplary set of embodiments, the sweetener component can be or include one or more natural sweeteners and/or an artificial sweeteners, such as Stevia, aspartame, sorbitol, erythritol, cane sugar, monk fruit, or similar known or hereafter developed low glycemic and/or low caloric sweeteners or compounds, while increasing sweetness.

In an exemplary set of embodiments, the additive comprises one or more fruit components. In some such embodiments, the fruit from which the one or more fruit components is derived is an apple. According to some such embodiments, the apple component is substantially colorless and odorless, or at least near colorless and odorless. In some embodiments, the apple component has a mild sweet taste. In an exemplary set of embodiments, the apple component has a mild sweet odor. According to some embodiments, the one or more fruit components is substantially colorless and odorless, or at least near colorless and odorless. In some embodiments, the one or more fruit components has a mild sweet taste. In an exemplary set of embodiments, the one or more fruit components has a mild sweet odor.

In an exemplary set of embodiments, the additive comprises one or more fruit components. In some such embodiments, the fruit from which the one or more fruit components is derived is an apple. According to some such embodiments, the apple component can have a calorie count of about 10 calories per ½ teaspoon (4 grams). In an exemplary set of embodiments, the sweetener component can lower glycemic index by about 10% or greater and calorie count by about I 0% or greater and increase sweetness by about 10% or greater. In some embodiments, other degrees of lowering the glycemic index and/or the calorie count and/or increasing the sweetness may be realized by the healthy sweetener.

In an exemplary set of embodiments, the healthy sweetener can be reconstituted with water such that its use in products can bear the FDA designation “no sugar added.”

In an exemplary set of embodiments, the additive comprises one or more fruit components. In some such embodiments, the fruit from which the one or more fruit components is derived is an apple. According to some such embodiments, the apple component can comprise apple peel, apple flesh, or a combination thereof. In an exemplary set of embodiments, the apple component can take the form of a solid, such apple flesh and/or apple peel in dried or granular form, as examples.

In an exemplary set of embodiments, the additive comprises one or more fruit components. In some such embodiments, the fruit from which the one or more fruit components is derived is an apple. According to some such embodiments, the apple component can include apple in a dried form. In an exemplary set of embodiments, the apple component is an apple in a solid or dried form, e.g., granules or powder.

In an exemplary set of embodiments, the additive comprises one or more fruit components. In some such embodiments, the fruit from which the one or more fruit components is derived is an apple. According to some such embodiments, at least a portion of the apple component in the solid form can be soluble. In some embodiments, at least a portion of the apple component in the solid form can be insoluble. In an exemplary set of embodiments, the apple component in the solid form can include an insoluble portion and a soluble portion. Other combinations of insoluble and/or soluble apple peel and/or flesh in dried form can be used to form the apple component.

It should be understood that the apple component is generally described as comprising apple, it may more broadly be a fruit component that comprises one or more other (e.g., non-apple) fruits as an alternative to or in combination with apple in dried form. In such embodiments, a healthy sweetener in accordance with aspects of the inventive concepts can include a fruit component and a sweetener component that lowers the glycemic index and calorie count of the fruit component while preferably increasing sweetness. It should further be understood that other, non-apple, fruit components may also be present in a solid form, e.g., as dried fruit, granules, and/or powder. In some embodiments, the additives and/or sweeteners described herein be used in recipes to replace other sweeteners (e.g., sugars, honey, maple syrup, artificial sweeteners, natural sweeteners).

In an exemplary set of embodiments, the healthy sweetener can be added to or used as an ingredient in the preparation of a variety of types of foods or beverages. In an exemplary set of embodiments, the healthy sweetener can be used as a dry condiment. In some embodiments, the healthy sweetener may be a solid configured to be reconstituted with a liquid, e.g., by adding a diluent such as water to the sweetener. In some such embodiments, the sweetener may be reconstituted and then further used as an ingredient and/or additive, for example, by adding to a beverage or food. In other embodiments, however, the healthy sweetener may simply be added to the food or beverage in solid form.

In an exemplary set of embodiments, the sweetener component increases the sweetness of the apple (or fruit) component. In some embodiments, the additive comprising the sweetener and/or the apple (or fruit) components, when added to a consumer product, can lower the glycemic index and/or the calorie count and/or increase the sweetness of the consumer product when compared to the consumer product sweetened by conventional sweeteners.

In an exemplary set of embodiments, the healthy sweetener can be used as a low glycemic, low calorie sweetener substitute in any food or beverage product in place of processed sugar, corn syrup, or other sweeteners. Such food products can include, but are not limited to, cereal, baked goods, sports bars, breakfast bars, granola, gummies and candies, yogurt, ice cream, mixes for baked goods, and so forth. Such beverages can include, but are not limited to, soft drinks, sodas, juices, teas, smoothies, vitamin supplement and/or probiotic drinks, waters, sports drinks, milks, and so forth. It should be understood that other foods and beverages are also possible, as this disclosure is not so limited. In some embodiments, the edible and/or consumable consumer product comprises at least one member selected from the group consisting of juice, soda, milk, tea, smoothie, water, sports drink, ketchup, mustard, mayonnaise, syrup, honey, jelly, peanut butter, butter, chocolate syrup, shortening, butter, margarine, oleo, grease, dip, yogurt, sour cream, oil, marshmallow, dough, batter, baked goods, chewing gum, bubble gum, butter, cheese, cream, cream cheese, mustard, yogurt, sour cream, curry, sauce, dessert toppings, whipped cream and toothpaste.

In some embodiments, the values and/or ranges of the above could be different. While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

Additional exemplary additives and sweeteners are described in at least U.S. provisional patent application 63/539,559 filed Sep. 20, 2023 and entitled Healthy Sweetener, U.S. provisional patent application 63/535,550 filed Aug. 30, 2023 and entitled Healthy Sweetener, U.S. provisional patent application 63/454,906 filed Mar. 27, 2023 and entitled Healthy Sweetener, and U.S. provisional patent application 63/598,528 filed Nov. 13, 2023 and entitled Healthy Sweetener, each of which are incorporated herein by reference in their entirety for all purposes.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A food and/or beverage additive, the additive comprising:
a sweetener comprising:
fructose present in an amount greater than or equal to 20 wt % and less than or equal to 60 wt % versus a total weight of the sweetener;
glucose present in an amount greater than or equal to 5 wt % and less than or equal to 35 wt % versus the total weight of the sweetener;
sorbitol present in an amount greater than or equal to 0.5 wt % and less than or equal to 10 wt % versus the total weight of the sweetener; and
sucrose present in an amount greater than or equal to 0 wt % and less than or equal to 20 wt %,
wherein the sweetener is solid and has one or more of the following properties:
i) a glycemic index of less than or equal to 55 as measured according to ISO 26642:2010; and/or
ii) a number of calories of less than or equal to 20 kilocalories per 4 grams of sweetener as measured using a bomb calorimeter.

2. The food and/or beverage additive as in claim 1, wherein the additive is a solid.

3. The food and/or beverage additive as in claim 1, wherein the additive further comprises one or more fruit components.

4. The food and/or beverage additive as in claim 3, wherein the one or more fruit components are derived from a fruit selected from the group consisting of pomes, citrus, gourds, berries and/or aggregate fruits, and drupes.

5. The food and/or beverage additive as in claim 4 wherein the fruit is an apple.

6. The food and/or beverage additive as in claim 3, wherein the one or more fruit components comprise peel/skin, flesh/pulp, pit, seed, sepal, pistil and/or pedicel.

7. The food and/or beverage additive as in claim 1, wherein the additive is in powder or granular form.

8. The food and/or beverage additive as in claim 1, wherein the additive has a shelf-life of greater than or equal to 1 year, greater than or equal to 2 years, or greater than or equal to 3 years, at room temperature.

9. The food and/or beverage additive as in claim 1, wherein the sweetener is water soluble.

10. The food and/or beverage additive as in claim 1, wherein the sweetener is substantially colorless and/or substantially odorless.

11. The food and/or beverage additive as in claim 1, wherein the sweetener further comprises one or more additional low glycemic, and/or low caloric, natural and/or artificial sweeteners.

12. The food and/or beverage additive as in claim 1, further comprising Stevia, aspartame, sorbitol, erythritol, cane sugar, monk fruit, and/or other natural and/or artificial sweeteners.

13. An edible consumer product, the edible consumer product comprising:
a food product; and
a coating and/or powder, the coating and/or powder comprising a sweetener, wherein the sweetener is a solid and the sweetener comprising:
fructose present in an amount greater than or equal to 20 wt % and less than or equal to 60 wt % versus a total weight of the sweetener;
glucose present in an amount greater than or equal to 5 wt % and less than or equal to 35 wt % versus the total weight of the sweetener;
sorbitol present in an amount greater than or equal to 0.5 wt % and less than or equal to 10 wt % versus the total weight of the sweetener; and
sucrose present in an amount greater than or equal to 0 wt % and less than or equal to 20 wt %.

14. The edible consumer product as in claim 13, wherein the edible consumer product meets FDA standards for a “no sugar added” designation according to 21 CFR 101.60 (c).

15. The edible consumer product as in claim 13, wherein the coating and/or powder further comprises one or more fruit components, the one or more fruit components derived from a fruit selected from the group consisting of pomes, citrus, gourds, berries and/or aggregate fruits, and drupes.

16. (canceled)

17. The edible consumer product as in claim 15, wherein the fruit is an apple.

18. The edible consumer product as in claim 15, wherein the one or more fruit components comprise peel/skin, flesh/pulp, pit, seed, sepal, pistil and/or pedicel.

19. (canceled)

20. The edible consumer product as in claim 13, wherein the sweetener has a shelf-life of greater than or equal to 1 year, greater than or equal to 2 years, or greater than or equal to 3 years, at room temperature.

21. The edible consumer product as in claim 13, wherein the sweetener is water soluble.

22. (canceled)

23. An edible consumer product as in claim 13, wherein the sweetener further comprises one or more additional low glycemic, and/or low caloric, natural and/or artificial sweeteners.

24. (canceled)
